(19) United States
(12) Patent Application Publication
(10) Pub. No.: US 2009/0202969 A1
(43) Pub. Date: Aug. 13, 2009

(54) CUSTOMIZED LEARNING AND ASSESSMENT OF STUDENT BASED ON PSYCHOMETRIC MODELS

(76) Inventors: Scott E. Beauchamp, Indianapolis, IN (US); Gus Koumarelas, Chicago, IL (US)

Correspondence Address: FENWICK & WEST LLP, SILICON VALLEY CENTER, 801 CALIFORNIA STREET, MOUNTAIN VIEW, CA, 94041, US

(21) Appl. No.: 12/350,958

(22) Filed: Jan. 8, 2009

Related U.S. Application Data
(60) Provisional application No. 61/020,109, filed on Jan. 9, 2008.

(51) Int. Cl. G09B 7/00

(52) U.S. Cl. 434/335; 434/362

(57) ABSTRACT

A method, a device and a computer readable storage medium for conducting a customized educational session to assess or teach a student by selecting contents for presentation to the student based on descriptors associated with questions and/or incorrect responses. The contents presented include both questions for assessing the student's knowledge state and intervention materials for teaching the student. The descriptors associated with the questions and incorrect responses are analyzed using one or more psychometric models to estimate the deficiency or weakness of the student's learning. Next contents are selected or created based on the estimated deficiency or weakness in the student's learning.

### CROSS-REFERENCE TO RELATED APPLICATIONS

This application claims a benefit of, and priority under 35 U.S.C. §119(e), to co-pending U.S. Provisional Patent Application No. 61/020,109 entitled “Adaptive Customized Learning System Including An Intelligent Diagnostic Engine” filed on Jan. 9, 2008, which is incorporated by reference herein in its entirety.

### BACKGROUND

1. Field of Art

The disclosure generally relates to the field of providing contents for teaching or assessing a student, more specifically, to diagnosing the knowledge state of the student and customizing contents provided to the student based on the knowledge state.

2. Description of the Related Art

Most computerized tests are administered with fixed-path questions. These fixed-path questions are predetermined and remain unchanged irrespective of answers provided by the students. Such fixed-path questions provide test results that may be analyzed to determine general strength or weakness of each student on a subject matter. The fixed-path questions, however, provide limited information about deficient learning of a specific topic or a subtopic of the subject matter. A teacher may manually review and analyze incorrect responses to the fixed-path questions to identify weak topics or subtopics of the student. Such manual review and analysis are time-consuming and often inaccurate, especially when a complex set of questions are administered to multiple students.

Some computerized tests utilize psychometric models such as item response theory (IRT) to select a subset of questions from a bank of questions to generate different but equivalent exams to test each student. For example, Computer-Adaptive Testing (CAT) for the Graduate Management Admission Test (GMAT) uses IRT to determine which question is the “best” next question for the student. Specifically, the CAT algorithm generally repeats the following steps until a stopping criterion is satisfied: (i) the level of a student is evaluated based on responses received up to a given point, (ii) all the questions that have not yet been administered are evaluated to determine which will be the best one to administer next, (iii) the “best” next question is administered and the student provides an answer to the question, and (iv) the student's level is estimated based on the answers to all of the previous questions. The CAT algorithm based on IRT allows more accurate assessment of the student's level using fewer questions.

Despite advancements in psychometrics, a majority of students are still being tested and evaluated using conventional fixed-path multiple choice exams. The fixed-path multiple choice exams may be administered conveniently to a large number of students. The fixed-path multiple choice exams, however, provide limited and inaccurate assessment of each individual student.

### SUMMARY

Embodiments disclose a method, a system, and a computer storage medium for providing a customized educational session to a student. A subsequent question for the student is selected or created by analyzing a response to the current question. The question and possible responses to the question are associated with descriptors that may be analyzed to determine the knowledge state of the student. The descriptors of the questions and the incorrect responses to the questions are provided to one or more psychometric models for estimating the knowledge state of the student.

In one embodiment, intervention materials are selected and provided to the students in lieu of the questions when certain conditions are satisfied. The student may be tested after being presented with the intervention materials to determine if the student advanced to a higher knowledge state.

In one embodiment, one or more questions are generated by using templates and variables associated with the templates. The variables are associated with descriptors to allow selection and incorporation of variables suitable for the next question. In this way, the knowledge state of the student can be accurately estimated even when there are no questions available to test the student. Subsequent questions may be created by selecting the template and adding variables with descriptors relevant to current knowledge state of the student. The variables may be selected so that confidence of the knowledge state may be increased by analyzing a response to the template-based question.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying drawings (Figures). The drawings (Figures) include the following:

FIG. 1 is a block diagram illustrating the architecture of an adaptive customized learning system, according to one embodiment.

FIG. 2 is a flow chart illustrating an overall process in the adaptive customized learning system, according to one embodiment.

FIG. 3 is a block diagram illustrating the architecture of a content creator in the adaptive customized learning system, according to one embodiment.

FIG. 4 is a flow chart illustrating the process of creating questions based on a template, according to one embodiment.

FIG. 5 is a block diagram illustrating the intelligent diagnostic engine of the adaptive customized learning system, according to one embodiment.

FIG. 6 is a flow chart illustrating the process of selecting contents for presentation based on a response from a student, according to one embodiment.

FIG. 7 is a flow chart illustrating the process of determining preferred intervention materials, according to one embodiment.

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles disclosed herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Embodiments disclosed include a method, a system and a computer readable storage medium for conducting a customized educational session for a student to assess or teach a student by presenting customized contents to a student based on descriptors associated with questions and/or incorrect responses. The contents presented include both questions for assessing the student's knowledge state and intervention materials for teaching the student. The descriptors associated with the questions and incorrect responses are analyzed using one or more psychometric models to estimate the deficiency or weakness in the student's learning. Next contents are selected or created based on the estimated deficiency or weakness in the student's learning. Customizing the contents provided to a student is advantageous because the student's knowledge state may be evaluated more accurately and the student may be taught more effectively.

A psychometric model refers to a model for evaluating mastery or deficiency of student's learning in a subject matter using mathematical analysis on a responder's responses to questions. Psychometric models may also indicate a relationship between learning components such as a precedence relationship between learning components. The precedent relationship indicates which learning components must be mastered before progressing to a more advanced learning component. Examples of the psychometric model include, IRT (Item Response Theory), and Bayesian Multidimensional Item Response Theory.

A responder is a person participating in an educational session for assessment or to learn a subject matter. The responder may include, for example, a student, a test taker or a candidate applying for a position. Embodiments and examples of this disclosure are described below using a student as an example of the responder. Other entities such as a test taker or candidate is interchangeable with the student described below.

### Architecture for Adaptive Customized Learning System

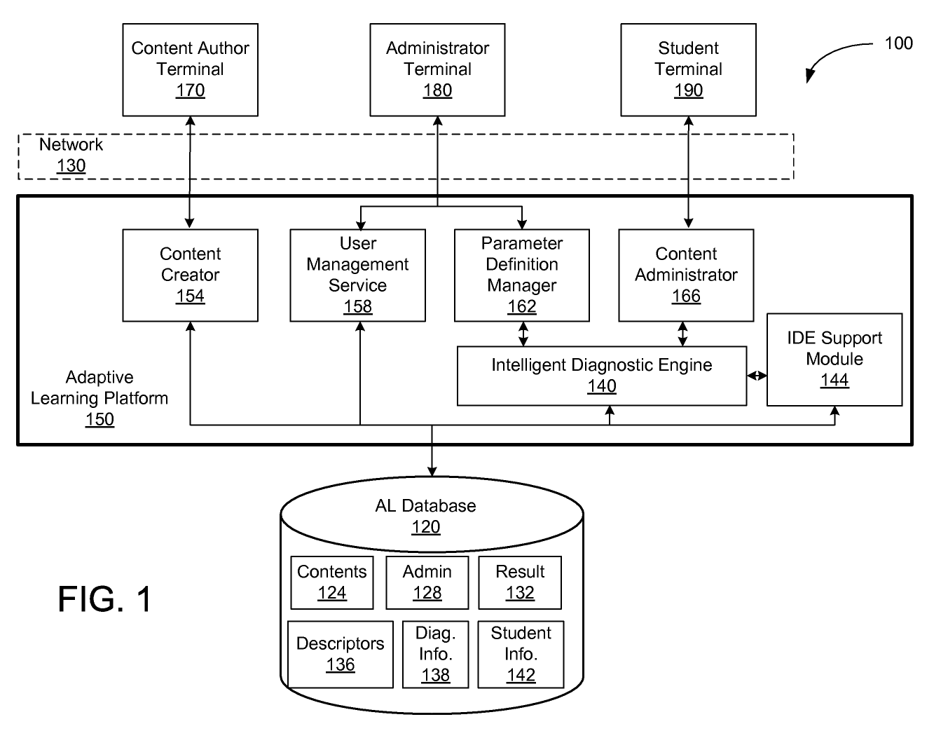

FIG. 1 is a block diagram illustrating the architecture of an adaptive customized learning system 100, according to one embodiment. The adaptive customized learning system 100 includes, among other components, an adaptive learning platform 150, a content author terminal 170, an administrator terminal 180, a student terminal 190, and an adaptive learning database 120. The content author terminal 170, the administrator terminal 180 and the student terminal 190 communicate with the adaptive learning platform 150 over a network 130. FIG. 1 illustrates one content author terminal 170, one administrative terminal 180 and one student terminal 190 merely for the convenience of explanation. In a typical adaptive customized learning system, multiple content terminals, multiple administrative terminals and multiple student terminals are deployed in the adaptive customized learning system 100.

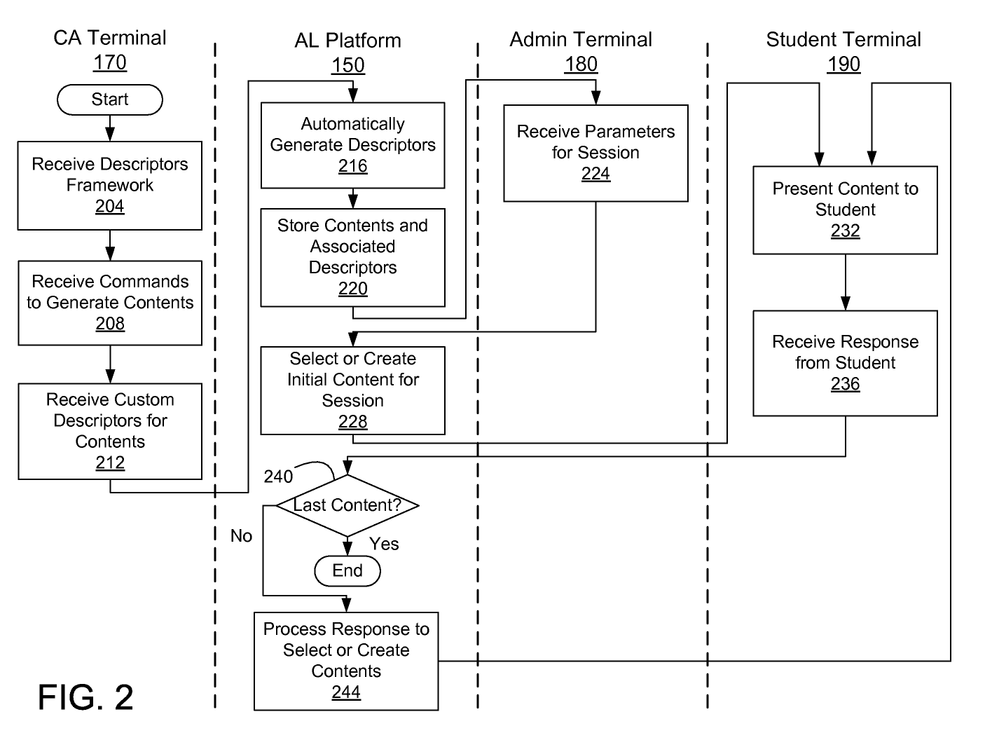

The content author terminal 170 is used by content authors to create, modify or update contents for presentation to students via the adaptive learning system 100. The content authors may include, for example, subject matter experts in educational institutions or commercial establishments and teachers. The content authors may access various resources and tools from the adaptive learning system 100 to create, modify or update contents. In addition to creating questions and identifying correct answers to the questions, the content authors may also provide descriptors for incorrect responses, as described below in detail with reference to FIG. 2.

The administrator terminal 180 is used by administrators of educational institutions to conduct various management operation associated with the educational institutions. The management operation may include, among others, assigning students and teachers to classrooms, designing and conducting exams or educational sessions using the adaptive learning platform 150, evaluating performance of teachers or students, scheduling events at the educational institutions.

The student terminal 190 is used by students to participate in educational sessions provided by the adaptive learning platform 150. The contents as selected or created by the adaptive learning platform 150 are presented to the student via the student terminal 190. Responses to questions from the student are also received at the student terminal 190 and forwarded to the adaptive learning platform 150.

The adaptive learning platform 150 is a combination of hardware and software components for performing various operations associated with administering customized educational sessions for students. The adaptive learning platform 150 includes, for example, communication modules (not shown), one or more processors (not shown), and memory (not shown). The communication modules communicate with other components of the adaptive customized learning system using known technology. In one embodiment, the communication module of the adaptive learning platform 150 allows the content author terminal 170, the administrative terminal 180 and the student terminal 190 to access other components of the adaptive learning platform. The one or more processors execute instructions stored on the memory to perform various operations associated with providing the customized educational sessions.

The adaptive learning platform 150 includes, among other components, a content creator 154, a user management service module 158, a parameter definition manager 162, a content administrator module 166, an intelligent diagnostic engine (IDE) 140, and an IDE support module 144. One or more of these modules may be embodied on the same hardware that shares one or more processors and the same memory devices. Alternatively, one or more of these modules may be embodied on a dedicated hardware with a separate processor and memory. One or more components of the adaptive learning platform 150 may be ported to or embodied on the content author terminal 170, the administrator terminal 180 or the student terminal 190.

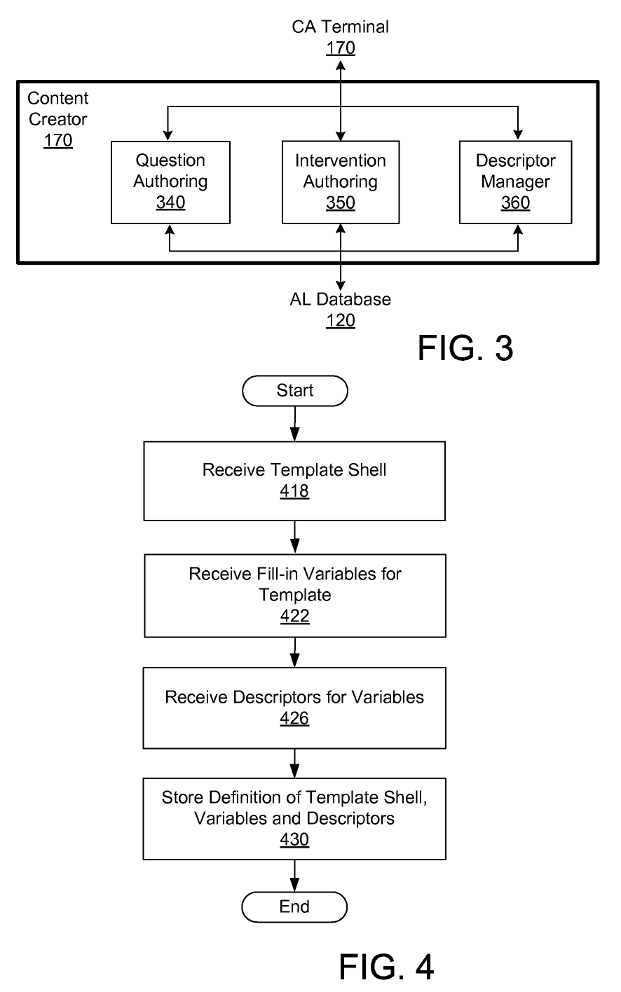

The content creator 154 functions in conjunction with the content author terminal 170 to facilitate the content authors' task of creating, modifying or updating contents for the adaptive learning platform 150, as described below in detail with reference to FIG. 3. The content creator 154 is coupled to the content author terminal 170 to interact with the content authors.

The user management service 158 functions in conjunction with the administrator terminal 180 to provide various management operations associated with the educational institutions. The user management service 158 may implement access control that allows different levels of access to different groups of administrators.

The parameter definition manager 162 functions in conjunction with the administrator terminal 180 to set session parameters associated with the educational sessions using the adaptive learning system 100. Specifically, the parameter definition manager 162 receives session parameters (for example, the number of questions, the type of educational session administered, the total time for the educational session, students to participate in the educational session, etc.) set by the administrator. The intelligent diagnostic engine 140 then creates and administers the educational session as defined by the session parameters.

The content administrator 166 functions in conjunction with the student terminal 190 to provide contents selected or created by the adaptive learning platform 150 to the student. In one embodiment, the content administrator module 166 formats the contents in a consistent manner for presentation to the student. Responses to the content from the student are received at the content administrator 166 and relayed to the intelligent diagnostic engine 140 for processing.

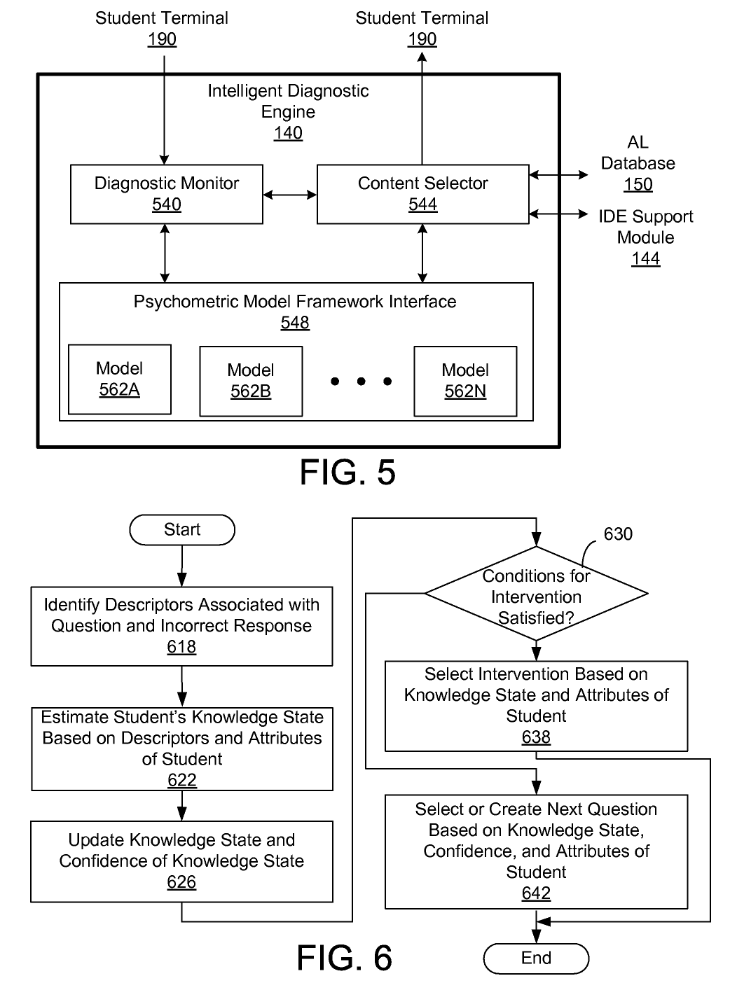

The IDE 140 customizes the contents to be provided to each student by diagnosing the student's knowledge state of a subject matter. The contents provided to the student are customized by analyzing descriptors associated with questions and responses to the questions received from the student, determining the knowledge state of the student based on the descriptors, and selecting and creating contents based on the knowledge state, as described below in detail with reference to FIGS. 5 and 6.

The IDE support module 144 analyzes information stored in the adaptive learning database 120 to support operation of the IDE 140 and to obtain various data to improve teaching techniques. Specifically, the IDE support module 144 may perform various types of data mining operations including, among others, the following: (i) evaluate the results of the educational sessions, (ii) determine optimal or preferred intervention materials for students at certain knowledge states, (iii) identify any attributes of students (for example, cultural bias or socioeconomic status of the student's family) correlated with incorrect responses to a category of questions, (iv) develop predictive models of a class of students (for example, a certain pattern of answers given in 8^{th} grade by students with specific attributes may predict that those students will experience difficulty in a certain type of questions in 11^{th} grade calculus), and (v) determine correlations and relationships between incorrect answers and a combination of descriptors (for example, a certain type of student is more likely to answer incorrectly when both descriptor A and descriptor B are associated with a question or response, even though the student may answer correctly when the descriptor A or B is presented independently). The results of the data mining operation may be used to modify the learning framework and generate new parameters or update the parameters or variables in the IDE engine 140 for selecting or creating contents presented to the student.

The adaptive learning database 120 stores various data associated with the operation of the adaptive learning platform 150. The data stored in the adaptive learning database 120 may include, among others, contents 124, administrative data 128, session results 132, descriptors 136 associated with the contents and responses, diagnostic information 138, and student information 142. The contents 124 include questions and intervention materials that may be selected by the IDE 140 for presentation to the students. The administrative data 128 includes information associated with various management operations performed on the user management service module 128. The session results 132 include, among others, contents presented to the student in educational sessions, responses from the students, descriptors associated with the responses, scores of the student (average or individual), time spent by the student before providing the response, the diagnosed knowledge states of the students, and other information obtained by conducting an educational session with the students. The descriptors 136 are associated with the contents and responses related to the contents, as described below in detail. The diagnostic information 138 includes the results of data mining operation performed by the IDE support module 144. The student information 142 includes attributes of the students that may be used by the IDE support module 144 for data mining operation. The student information 142 includes, for example, age, gender, family status, race, student's primary language, and socioeconomic status of student's family.

In one embodiment, the adaptive learning system 100 tracks the time of student interactions to modify the interaction with the student. The content administrator 166 or the student terminal 190 may track the range, median and average time spent by the student in providing responses. The time tracked by the content administrator 166 or the student terminal 190 may be provided to the intelligent diagnostic engine 140 to select or create contents based on the tracked time. Further, a notification may be presented to the student via the student terminal 190 or to the teacher via the administrator terminal 180 after events based on tracked time are detected. For example, if a student spends an inordinate amount of time on one question, a text or video notification can be presented to the student suggesting that the student move on and come back to the question later or provide a hint based on the student's knowledge state. If a student is moving too quickly and likely guessing answers, a text or video notification may be presented to the student requesting the student to spend more time on each question. If a student spends a long time on a question, and then starts to respond incorrectly to subsequent questions or spends too little time, this may indicate test fatigue. In such case, the exam may be terminated or the student may be presented with other contents to refresh the student's attention. A teacher may also be alerted of the student's status via the administrator terminal 180 to prompt the teacher to take necessary actions for the student.

### Descriptors Associated with Contents and Responses

The IDE 140 uses descriptors associated with questions and possible responses to the questions in order to estimate the student's knowledge state and to customize contents for the student's based on the estimated knowledge state. The descriptors are meta data associated with contents themselves as well as the incorrect responses to the contents. The descriptors associated with contents may include, among others, the subject matter of the question (for example, mathematics and science), the difficulty level of questions (for example, easy, intermediate and advanced), and the attributes of the contents (for example, covering distributive property in algebra). The descriptors associated with incorrect responses indicate one or more reasons that may cause the student to choose an incorrect response. For example, a descriptor for “8” as an incorrect response to the question “What is 4 to the power of 2?” indicates that the student is likely confusing the concepts of exponentiation and multiplication. Other distracters to the same question may indicate other misunderstanding or deficient learning causing the student to choose the other distracters.

The knowledge state of the student may be determined more accurately and promptly by analyzing the descriptors associated with incorrect responses received from the students. When creating questions for exams or other educational sessions, content authors generally invest a significant amount of time and effort to add distracters to induce incorrect responses from students who have not sufficiently mastered a topic or a subtopics. In conventionally structured exams, however, information related to distracters is not used in real-time analysis of the student's knowledge status. In one or more embodiments, information about the distracters in the questions are retained and made available for analysis in the form of descriptors of incorrect responses. For example, a descriptor of one incorrect response may indicate misunderstanding of the concept of double negation while a descriptor of another distracter may indicate misunderstanding about arithmetic with absolute values.

The descriptors may be structured in multiple layers where each layer of descriptors provides different types of information. For example, a layer of descriptors may indicate general attributes of the contents such as the level of questions, a topic or a subtopic covered by the contents, and the length of questions. Another layer of descriptors may be associated with distracters to indicate one or more reasons that may cause the student to choose an incorrect response. For example, in math questions, the layer of descriptors associated with the distracters may be “sign error,” “incomplete processing,” and “incorrect addition of fractions by adding numerators and denominators.” Further, different layers of descriptors may be created by different entities. For example, initial layers of descriptors may be created by content authors on top of which one or more layers of descriptors may be created and overlaid by an administrator (for example, a teacher) to independently assess the students without interfering with the descriptors created by the content authors.

It is preferable for a content author to provide the initial layers of descriptors because the content author is most likely to know the attributes of the questions and the likely reason that a student chooses incorrect responses. The descriptors, however, may be created by someone else when the descriptors were not created by the content authors. For example, preexisting contents designed for conventional learning systems may not include any descriptors. In such cases, a subject matter expert with expertise in the subject matter may analyze the contents and create descriptors for the contents.

Further, at least part of the descriptors may be generated automatically by the adaptive learning platform 150. Certain attributes of the contents and/or responses are amenable for analysis by an automatic algorithm. Descriptors based on such attributes may be created automatically without any inputs from content authors or administrators. For example, descriptors associated with the lengths of text in the questions or the number of choices in multiple choice questions may be created automatically by the adaptive learning platform 150.

The descriptors may also be associated with intervention materials. The intervention materials refer to educative materials other than questions that are presented to the student to improve or advance the student from the current knowledge state. The descriptors associated with the intervention materials may include, among others, the author of the intervention materials, the appropriate knowledge state for accessing the intervention materials, and time or place where the intervention materials were created.

### Process of Conducting an Educational Session

FIG. 2 is a flow chart illustrating an overall process in the adaptive customized learning system 100, according to one embodiment. A framework for descriptors of the contents is received 204 at the content author terminal. The descriptors framework defines the structure of descriptors including, among others, which descriptors should be provided for the contents created by the content authors and which descriptors should be generated automatically by the adaptive learning platform, the number of layers of descriptors, and the relationship between the layers of descriptors. Different psychometric models may require different descriptor frameworks. In such cases, more than one descriptor framework may be defined for the same contents. In one embodiment, default descriptor frameworks may be available from the content author terminal 170 or the content creator 154 that may be selected and invoked by the content author.

Commands are also received 208 at the content author terminal 170 to create contents. In one embodiment, convenient user interfaces including drag-and-drop features are provided to facilitate creation of the contents. Descriptors associated with the contents are received 212 from the content authors via the content author terminal 170. In one embodiment, the content author terminal 170 presents a user interface that allows the user to conveniently input the descriptors according to the descriptor framework previously defined or selected by the content author.

The adaptive learning platform 150 receives the contents, and automatically generates 216 one or more descriptors associated with the contents (for example, descriptors related to the lengths of text in questions). The contents and their associated descriptors are then stored 220 in the adaptive platform database 120. The processes of receiving 208 commands through storing 220 contents may be repeated until all contents needed for conducting an educational session are prepared.

In order to conduct an educational session, session parameters needed for setting up the educational session are received 224 from an administrator at the administrative terminal 180. The session parameters include, for example, the number of questions, the type of the educational session administered (e.g., exam only session or exam combined with teaching session), the total time for the session, the number and identity of students to participate in the educational session, etc.

After the session parameters are set, the adaptive learning platform 150 selects or creates 228 an initial content (e.g., question) to be presented to the student as the first content. The initial content is then sent to the student terminal 190 via the network 130. The initial content is then presented 232 to the student via the student terminal 190. A response to the initial content is received 236 from the student terminal 190. The response may be either a correct response or an incorrect response to the content.

The student terminal 190 sends the response from the student to the adaptive learning platform 150. If it is determined 240 that the content presented to the student was the last content as defined by the session parameters, then the process ends. If it is determined 240 that there are subsequent contents to be presented to the student, then the response to the previous content is processed 244 to select or create a next content. Then the process returns to presenting 232 the content to the student.

The sequence of processes illustrated in FIG. 2 is merely illustrative and the processes may be performed in a different sequence. For example, the definition of descriptor framework may be received 204 after receiving the contents 208. This may be the case when a preexisting package of contents is being modified for use in the adaptive learning system 100. Furthermore, one or more processes may be omitted. For example, when intervention materials are being provided to the student, no response may be received 236 from the student. In such case, the process proceeds directly to determining 240 whether the intervention materials is the last content.

### Creation of Contents for Adaptive Learning Platform

FIG. 3 is a block diagram illustrating the architecture of the content creator 170 of the adaptive customized learning system 100, according to one embodiment. The content creator 170 includes, among other components, a question authoring module 340, an intervention authoring module 350 and a descriptor manager 360. The question authoring module 340 is accessed by the content author terminal 170 to create questions. The questions created using the questioning authoring module 340 include various types of questions including, among others, multiple choice questions, multiple response questions, matching questions, gap-fill questions, and free response questions. The question authoring module 340 in conjunction with the content author terminal 170 processes the inputs from the content author to create contents compatible with the adaptive learning system 100.

The intervention authoring module 350 is also accessed by the content author terminal 170 to create intervention materials for the student. The intervention materials may be presented to the user in lieu of addition questions to advance the student from a current knowledge state to a higher knowledge state. The intervention materials may include various types of educative materials such as audio files, reading materials, movie clips, and flash videos. The intervention materials need not be presented during the educational session. That is, the selected intervention materials may be presented to the students outside the educational session. For example, a user may participate in a music lesson every Tuesday or participate in math games after school or be offered a nutritional breakfast at the start of each school day. Each intervention material may also be associated with descriptors indicating various attributes of the intervention material such as the length of the intervention materials, the level of understanding needed to access the intervention material, the creators of contents, the subject matter covered by the intervention material, teaching methodology, and the context of the intervention material.

The description manager 360 is responsible for associating descriptions with the contents. The descriptions manager 360 receives the descriptors or automatically generates the descriptors. The descriptors together with their association with the contents are then stored in the adaptive learning database 120 for reference by the IDE 140 during the educational session.

In one embodiment, at least a portion of the questions presented to the students is created by the adaptive learning platform 150 based on the templates for contents. By using the template, a variety of contents may be created automatically by the adaptive learning platform 150 without requiring the content authors to create all the questions individually. The variables to populate blank fields of the template may be associated with descriptors to enable the IDE 140 to customize the question for presentation to the user based on the knowledge state of the students.

FIG. 4 is a flow chart illustrating the process of designing questions based on a template, according to one embodiment. First, a template shell is received 418 from the content author. The template shell includes at least the following information: (i) standardized part of questions that remains unchanged, and (ii) blank fields to be filled with different variables for different questions. An example of template shell for a math question is as follows: “John has [Variable A: Integer less than 10] [Variable B: Noun associated with template]. If Sally takes [Variable C: Integer less than 10], how many [Variable B] does John have left?” In this example, the texts in the bracket are the blank fields to be filled with different variables. The remaining texts in the template shell are the standardized part of the questions.

Referring back to FIG. 4, the variables to fill the blank fields of the template are received 422. Descriptors for variables are also received 426. For example, in a template for an arithmetic question related to adding two numbers, a set of variables may be associated with a descriptor indicating one digit numbers while another set of variables may be associated with a descriptor indicating two digit numbers. The descriptor may be referenced by the IDE 140 to create questions that are customized to estimate the knowledge state of the student being tested, as described below in detail with reference to FIG. 6. For example, the IDE 140 may generate questions with two digit numbers in math questions to determine if the student is at a knowledge state where the student can address two digit numbers.

The template shell, fillable variables and the descriptors associated with the variables are stored 430 in the adaptive learning platform 150. In one embodiment, questions are created using the template shell, variables and descriptions only when there is no question available in the adaptive learning database 120 that matches conditions for the next question. After a question is created from the template shells and variables, the created question is stored 430 in the adaptive learning database 120 and becomes part of a bank of questions available for use during a subsequent educational session.

### Selecting or Creation of Customized Contents

FIG. 5 is a block diagram illustrating the IDE 140 of the adaptive customized learning platform 150, according to one embodiment. The IDE 140 includes, among other components, a diagnostic monitor 540, a content selector 544, and a psychometric model framework interface 548.

The diagnostic monitor 540 is responsible for tracking and diagnosing the knowledge state of the student. The diagnostic monitor 540 analyzes student's responses, determines descriptors associated with the responses, and estimates the knowledge state of the student based on the descriptors. The knowledge state is estimated by referencing one or more of the psychometric models 562A through 562N. The knowledge state tracked by the diagnostic monitor 540 may be updated as new responses are received from the student.

The psychometric model framework interface 548 stores multiple psychometric models 562A through 562N and interoperates with the diagnostic monitor 540 and/or the content selector 544. The psychometric models include information for evaluating the knowledge state of the student. Different psychometric models may require different types of information to evaluate the knowledge state of the student. The psychometric model framework interface 548 operates in conjunction with the diagnostic monitor 540 to convert the descriptors to input data appropriate for processing by the psychometric models 562A through 562N. Examples of the learning framework model include IRT (Item Response Theory), and Bayesian Multidimensional Item Response Theory. Based on the responses to contents received from the student, the psychometric model framework interface 548 estimates the knowledge states.

In one embodiment, each of the models 562A through 562N represents models for different subject matters or topics. In another embodiment, two or more of the models 562A through 562N are directed to the same subject matter. In this case, the psychometric model framework interface 548 provides information to the diagnostic monitor 540 and/or the content selector 544 regarding the knowledge state as determined from different psychometric models covering the same subject matter. Further, the psychometric model framework interface 548 may also generate and send confidence about the estimated knowledge state.

Each of the psychometric models 562A through 562N may be developed by different entities. Further, each of the psychometric models 562A through 562N may structure the knowledge states differently, and therefore, assign the student to different knowledge states based on the same responses. In one embodiment, the content selector 544 and/or the diagnostic monitor 540 uses the results from the psychometric model that indicates the highest confidence about the knowledge state based on the responses received from the student up to a certain point.

The psychometric models 562A through 562 deployed in the psychometric model framework interface 548 need not be fixed. As new psychometric models are developed and become available, new psychometric models may be installed in the psychometric model framework interface 548 as an API (Application Programming Interface). By not committing to one psychometric model, the adaptive learning platform 150 becomes more versatile and flexible to accommodate new developments in psychometrics. Further, the IDE support module 144 may perform operations based on different psychometric models to evaluate the effectiveness or accuracy of the psychometric models. The IDE engine 140 may then be updated to adjust the confidences associated with the psychometric models or choose one psychometric model over others.

Descriptors associated with incorrect responses allow the diagnostic monitor 540 to diagnose the knowledge state of the student more accurately at a detailed level based on fewer responses compared to instances of using only the descriptors about the questions. In one embodiment, the diagnostic monitor 540 uses the descriptors of the questions and whether the student correctly answered the questions to make a general estimation of the knowledge state. The descriptors associated with specific responses chosen by the student are then used to narrow down the estimation of the knowledge state to a detailed level. Further, by using the descriptors associated with the incorrect responses, fewer responses from the students are needed to accurately assess the knowledge state of a student because information for assessing the student otherwise unavailable from the descriptors of the questions is readily available from the descriptors associated with the incorrect responses.

The content selector 544 is responsible for determining the next content for presentation to the student based on the knowledge state estimated by the diagnostic monitor 540 and/or the psychometric model framework interface 548. In one embodiment, the content selector 544 selects or creates one or more questions that are likely to increase the confidence about the estimation of the knowledge state by eliminating one or more possible causes of incorrect responses from the student. For example, if a student responded incorrectly to a question with a distracter associated with concepts A and B, the content selector 544 may select or create one or a series of subsequent questions including only concept A or B. By analyzing the response to the subsequent question(s), the diagnostic monitor 540 may accurately determine that the student has deficient understanding of concept A, concept B or both.

In one embodiment, when the diagnostic monitor 540 determines the knowledge state of the student with a threshold level of confidence, the content selector 544 selects or creates intervention materials adapted for the knowledge state of the student. In some cases, one or more intervention materials suitable for a certain knowledge state of the student may be available from the adaptive learning database 120. In such case, the content selector 544 may recommend or automatically select a preferred content that is evaluated by the IDE support module 144 as being the most effective.

Further, the adaptive learning database 120 may store multiple levels of intervention materials, each level progressively requiring more time or effort on the part of the student to finish the intervention materials. If the student does not progress to the next level of knowledge state after being presented with a first level of intervention materials, the student may be presented with a second level of intervention materials. The second level of intervention materials may be longer or include more examples compared to the first level of intervention materials.

FIG. 6 is a flow chart illustrating processing of a response from a student to select a next content for the student, according to one embodiment. First, the descriptors associated with the question and the descriptors associated with the incorrect response are identified 618. The descriptors for the incorrect response to the questions may be identified by searching the descriptors of the distracters stored in the adaptive learning database 120.

The student's knowledge state is then estimated 622 based on the descriptors and the attributes of the student. The student's incorrect response may be related to his attributes. For example, a student may provide an incorrect response to a math question not because of incomplete processing but because the student's primary language is Spanish and did not understand the question presented in English. The attributes of the student relevant to the estimation of the knowledge state include, among others, gender, primary language, age, and race.

Based on the estimation, the knowledge state of the student and the confidence about such knowledge state are updated 626. As described above, more than one knowledge state associated with different psychometric models, as well as the confidence about such knowledge states, may be tracked and updated by the diagnostic monitor 540.

After updating the knowledge state and the confidence, it is determined 630 whether conditions for presenting intervention materials are satisfied 630. The conditions for presenting the intervention materials include, for example, whether the session parameters set by the administrator allows intervention materials and whether a threshold confidence level for presenting the intervention materials is reached. If the conditions for intervention material are satisfied, intervention materials are selected 638 based on the knowledge state of the student and the attributes of the student. After selecting the intervention materials, the process terminates.

Conversely, if the conditions for presenting the intervention materials are not satisfied, a next question in lieu of the intervention materials is selected or created 642 by the content selector 544 based on the knowledge state, the confidence of the knowledge state and the attributes of the student. In one embodiment, the content selector 544 may generate two or more questions responsive to receiving a single response from the student. After selecting or creating the next question, the process terminates.

### Data Processing at Selecting or Creation of Customized Contents

The IDE support module 144 may process data available from the adaptive learning database 120 to extract various types of useful information. Further, experiments may be performed by the IDE support module 144 to identify effective teaching methods or correlation between various attributes of the students and learning deficiencies. For example, an experiment may be performed on students to identify effective intervention materials for student at a certain knowledge state.

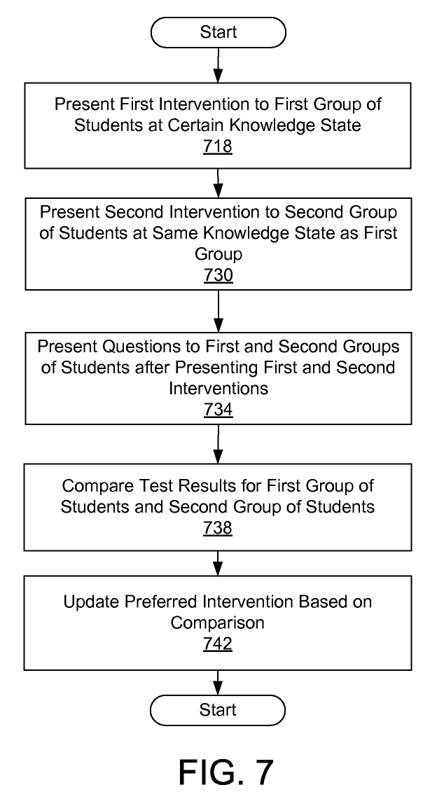

FIG. 7 is a flow chart illustrating a process of determining preferred intervention materials, according to one embodiment. First intervention materials are presented 718 to a first group of students at a certain knowledge state. Second intervention materials are presented 730 to a second group of students at the same knowledge state. After presenting the first or second intervention materials to the first and second groups of students, one or more evaluation questions are presented 734 to the students to evaluate advancement of the students.

The test results of the first group of students and the second group of students are compared 738 to determine which one of the two intervention materials are more effective. After evaluating the two intervention materials, the preferred intervention material is updated 742 for use by the IDE 140.

Although only two intervention materials were compared in the example of FIG. 7, three or more intervention materials may be evaluated in a similar manner by dividing the students into more than two groups, presenting different intervention materials to each group of students and evaluating the performance of students in each group.

The attributes of the students may be received and stored as the student information 142 in the adaptive learning database 120. The student information 142 may be used to identify any correlation between the attributes of the students and various learning attributes.

### Alternative Embodiments

Although embodiments were described with reference to educational sessions where subsequent contents are determined based on the responses from students, fixed-path exams with a predetermined sequence of questions may also use the descriptors described in this disclosure. Alternatively, a portion of an educational session may be administered using fixed-path exams and the remainder of the educational session may be administered using the responses received during the fixed path exams.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Advantages of the customized learning include, among others, more accurate evaluation of the responder with fewer questions and providing of educational materials more effective in advancing the student.

Upon reading this disclosure, those of skill in the art will appreciate still additional alternative structural and functional designs for a system, a method and a storage medium for providing a customized educational session to a student through the disclosed principles herein. Thus, while particular embodiments and applications have been illustrated and described, it is to be understood that the present disclosure is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

We claim:

1. A computer-implemented method for providing a customized educational session, comprising:
presenting a first question to a responder, the first question associated with one or more incorrect responses, each incorrect response associated with a descriptor representing a likely reason for selecting the incorrect response;
estimating a knowledge state of the responder by analyzing the descriptor associated with an incorrect response received from the responder based on a plurality of psychometric models;
selecting one of the plurality of the psychometric models with highest confidence based on the received incorrect response;
selecting or creating a second question based on the estimated knowledge state, a response to the second question likely to increase the confidence of the selected psychometric model;
presenting the second question to the responder;
selecting a first intervention material based on the knowledge state of the responder; and
presenting the intervention material to the responder.

2. The method of claim 1, wherein the responder comprises a student.

3. The method of claim 1, further comprising:
presenting an evaluation question directed to a topic covered by the first intervention material;
receiving an evaluation response to the evaluation question responsive to presenting the evaluation question;
selecting a second intervention material responsive to the evaluation response being incorrect; and
presenting the second intervention material to the responder.

4. A computer-implemented method for providing a customized educational session, comprising:
presenting a first question to a responder, the first question associated with one or more incorrect responses, each incorrect response associated with a descriptor representing a likely reason for selecting the incorrect response;
estimating a knowledge state of the responder by analyzing the descriptor associated with an incorrect response received from the responder;
selecting or creating a second question based on the estimated knowledge state; and
presenting the second question to the responder.

5. The computer-implemented method of claim 4, further comprising:
selecting a first intervention material based on the knowledge state of the responder; and
presenting the first intervention material to the responder.

6. The computer-implemented method of claim 5, further comprising:
presenting an evaluation question directed to a topic covered by the first intervention material;
receiving an evaluation response to the evaluation question responsive to presenting the evaluation question;
selecting a second intervention material responsive to the evaluation response being incorrect; and
presenting the second intervention material.

7. The computer-implemented method of claim 4, further comprising:
estimating a first knowledge state by a first psychometric model;
generating a first confidence based on the descriptor associated with the incorrect response, the first confidence representing likelihood that the first knowledge state is accurate;
estimating a second knowledge state by a second psychometric model; and
generating a second confidence based on the descriptor associated with the incorrect response, the second confidence representing likelihood that the second knowledge state is accurate;
wherein the second question is selected or created based on the first knowledge state, the second knowledge state, the first confidence and the second confidence.

8. The computer-implemented method of claim 7, wherein the second question is selected or created to increase at least one of the first confidence or the second confidence responsive to analyzing a response to the second question.

9. The computer-implemented method of claim 4, further comprising:
receiving a definition of a template for generating the second question; and
creating the second question by adding one or more variables associated with the template, each variable associated with a descriptor representing attributes of the variable.

10. The computer-implemented method of claim 4, further comprising:
presenting a first invention material to a first group of responders;
presenting a second intervention material to a second group of responders;
evaluating the first group of responders and second group of responders responsive to presenting the first or second intervention material; and
determining a preferred intervention material between the first and second intervention materials based on the evaluation.

11. The computer-implemented method of claim 4, further comprising receiving session parameters associated with the educational session, the second question created or selected to comply with the session parameters.

12. The computer-implemented method of claim 4, further comprising:
storing results of the educational session;
receiving and storing attributes of the responder; and
analyzing the results and the attributes of the responder to identify correlation.

13. The computer-implemented method of claim 4, wherein the descriptor is generated automatically by analyzing attributes of the incorrect response.

14. The computer-implemented method of claim 4, wherein the responder comprises a student.

15. The computer-implemented method of claim 4, further comprising generating a notification based on an amount of time spent by the responder in providing a response to the first or second question.

16. An adaptive learning system for providing a customized educational session, comprising:
a content administrator configured to present a first question to a responder and a second question to the responder, the first question associated with one or more incorrect responses, each incorrect response associated with a descriptor representing a likely reason for selecting the incorrect response; and
an intelligent diagnostic engine configured to estimate a knowledge state of the responder by analyzing the descriptor associated with an incorrect response received from the responder, the intelligent diagnostic engine further configured to select or create the second question based on the estimated knowledge state.

17. The adaptive learning system of claim 16, the intelligent diagnostic engine further configured to select a first intervention material based on the knowledge state of the responder, the content administrator further configured to present the first intervention to the responder.

18. The adaptive learning system of claim 16, the intelligent diagnostic engine comprising:
a first psychometric model for generating a first estimation of the knowledge state based on the descriptor associated with the incorrect response; and
a second psychometric model for generating a second estimation of the knowledge state based on the descriptor associated with the incorrect response, the intelligent diagnostic engine selecting or creating the second question based on the first estimation or the second estimation.

19. The adaptive learning system of claim 16, further comprising a content creator adapted to receive a definition of a template for generating the second question, the second question created by adding one or more variables associated with the template, each variable associated with a descriptor representing attributes of the variable.

20. The adaptive learning system of claim 16, further comprising a parameter definition manager for receiving session parameters associated with the educational session, the second question created or selected to comply with the session parameters.

21. The adaptive learning system of claim 16, wherein the content administrator is configured to track an amount of time spent by the user in responding to the first question or the second question, the intelligent diagnostic engine configured to select or create the second question based on the amount of time.

22. A computer readable storage medium storing instructions for providing a customized educational session customized to a responder, the instructions when executed cause the processor to:
present a first question to a responder, the first question associated with one or more incorrect responses, each incorrect response associated with a descriptor representing a likely reason for selecting the incorrect response;
estimate a knowledge state of the responder by analyzing the descriptor associated with an incorrect response received from the responder;
select or create a second question based on the estimated knowledge state; and
present the second question to the responder.

23. The computer readable storage medium claim 22, further comprising instructions causing the processor to:
select a first intervention material based on the knowledge state of the responder; and
present the first intervention to the responder.

24. The computer readable storage medium claim 22, further comprising instructions causing the processor to:
generate a first confidence based on the descriptor associated with the incorrect response, the first confidence representing likelihood that the first knowledge state is accurate;
estimate a second knowledge state by a second psychometric model; and
generate a second confidence based on the descriptor associated with the incorrect response, the second confidence representing likelihood that the second knowledge state is accurate;
wherein the second question is selected or created based on the first knowledge state, the second knowledge state, the first confidence and the second confidence.

25. The computer readable storage medium claim 22, further comprising instructions causing the processor to:
receive a definition of a template for generating the second question; and
create the second question by adding one or more variables associated with the template, each variable associated with a descriptor representing attributes of the variable.

26. The computer readable storage medium claim 22, further comprising instructions causing the processor to receive session parameters associated with the educational session, the second question created or selected to comply with the session parameters.

27. The computer readable storage medium of claim 22, further comprising instructions causing the processor to generate a notification based on an amount of time spent by the responder in providing a response to the first or second question.
